(19) United States
(12) Patent Application Publication
(10) Pub. No.: US 2011/0270784 A1
(43) Pub. Date: Nov. 3, 2011

(54) AUTOMATICALLY MONITOR, DETECT, ISSUE CITATION, AND COLLECT FINES FOR DRIVING VIOLATIONS USING MOBILE DEVICE

(76) Inventors: Kirit Damodardas Padia, Cary, NC (US); Suvas Manubhai Shah, Cary, NC (US); Bharat Damodardas Padia, Cary, NC (US)

(21) Appl. No.: 12/772,501

(22) Filed: May 3, 2010

(51) Int. Cl. G06Q 90/00

(52) U.S. Cl. 705/500

(57) ABSTRACT

A method to allow government law enforcement agencies and their representatives to automatically monitor, detect, and issue citation to collect fines for driving violations such as using mobile device for phone calls, sending text messages, or reading received text messages while driving. Information regarding these driving violations are captured and transmitted to back-office servers located at strategic locations for automatic enforcement including issuance of citations and collection of fines through mobile device billing system or sending citation through mail. Broader and efficient enforcement of the Safety Regulations will reduce the number of violations, improve the safety on the roads, and provide a mechanism to automatically collect fines.

### BACKGROUND OF THE INVENTION

The present invention is to improve safety regulations on the road. With invention of mobile devices, most of the individuals use these mobile devices to communicate with others and also use “texting” for chat. Moving the eyes from the road to the mobile device for texting causes many accidents on the road. Many states have regulations that disallow texting in moving vehicles. Mobile and Cellular devices have built-in sensors to keep in contact with cellular towers and have knowledge of exact position. Change in position is used to indirectly detect the speed of a moving vehicle where the mobile device is in the vehicle. When the vehicle is moving, detection of use of mobile device for a phone conversation or texting may constitute a violation based on the local state and federal laws. Excessive speeding beyond the speed limit also constitutes a violation can also be addressed using mobile device.

### SUMMARY OF THE INVENTION

Current mobile and cellular devices provide functions for voice communications and sending/receiving text messages with different people and also broadcasting text messages to a distribution list. Sender of the text message has no knowledge of receiver's activity at that time. It is human behavior to review the message as soon as mobile device beeps for incoming message. In many situations, person may be driving a vehicle at that instant. When a driver of the vehicle receives a text message on his or her mobile device, first reaction is to read the received text message. They also try to respond to the text message. Taking the eye from the road has caused many accidents. This invention provides capability to detect when a text message is reviewed or responded. It also provides automatic capability to issue a citation and collect fine by charging to mobile device bill or mail citation to the home address of owner of the mobile device.

Based on detecting the position of mobile device, a mobile device can detect the speed of the vehicle. A citation can be issued when the vehicle is moving at speeds above the threshold. With cooperation from the mobile service providers, citation charges can be added to the mobile device bill.

### BRIEF DESCRIPTION OF DRAWINGS

FIG. 1 is a diagram of a sample wireless cellular network in which present invention is implemented.

FIG. 2 is a flowchart of the transformation with mobile device detecting the conditions and further depicts the flow of information to Safety and Law Enforcement Systems server(s) to issue citation and collect fines demonstrating present invention.

### DETAILED DESCRIPTION OF THE PREFERRED EMBODIMENT

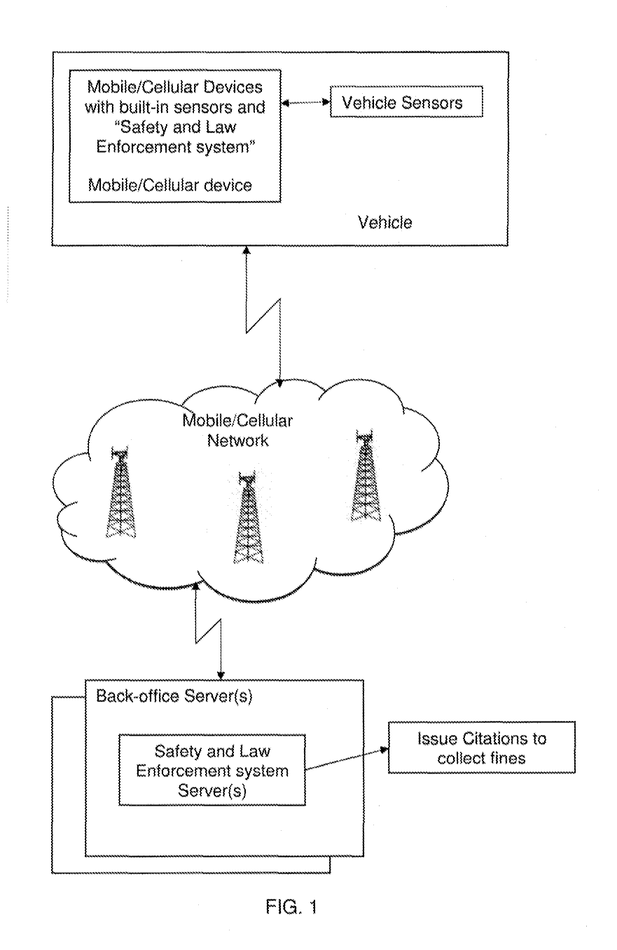

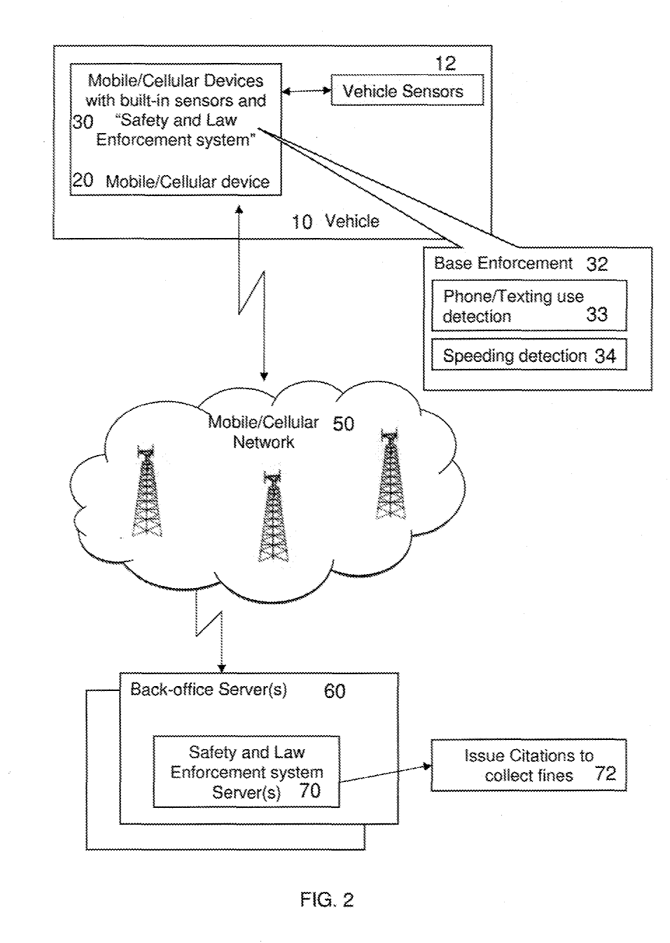

The present invention as demonstrated in FIG. 1 provides an automatic mechanism to detect and enforce safety violations. FIG. 2 details the flow of information in present invention using Safety Law Enforcement System 30 on a mobile device 20 and assistance of vehicle sensors 12 to monitor, detect, and enforce safety violations of a driver driving a vehicle 10. Safety Law Enforcement System 30 with mobile device 20 capabilities uses position of the mobile device to determine whether vehicle 10 is moving or not. Vehicle 10 has to be moving above minimum threshold speed to consider vehicle as moving. If the vehicle is moving at speeds above higher thresholds, it is a considered a speeding violation 34 and can be enforced the same way. If driver is sending or reading a text message 33 or using mobile phone 20 when the vehicle 10 is moving above minimum threshold, it is considered as a texting usage violation 33 or a mobile phone usage violation 33 as applicable in certain states. When violation is detected by Safety and Law Enforcement System 30, it will transmit the information through mobile network 50 to the Safety and Law Enforcement System Servers 70 running on back-office servers 60 located at strategic locations. Safety and Law Enforcement Server will issue a citation 72 to the driver and possibly collect fines through the cellular device phone bill.

What we claim is new and desire to secure by Letters Patent is:

1. A method to allow government law enforcement agencies and their representatives to automatically monitor, detect, and issue citation to collect fines for driving violations such as using mobile device for phone calls, sending text messages, or reading received text messages while driving.
